(19) United States
(12) Patent Application Publication
(10) Pub. No.: US 2024/0135258 A1
(43) Pub. Date: Apr. 25, 2024

(54) METHODS AND APPARATUSES FOR DATA PRIVACY-PRESERVING TRAINING OF SERVICE PREDICTION MODELS

(71) Applicant: Alipay (Hangzhou) Information Technology Co., Ltd., Hangzhou (CN)

(72) Inventors: Longfei Zheng, Hangzhou (CN); Chaochao Chen, Hangzhou (CN); Li Wang, Hangzhou (CN); Benyu Zhang, Palo Alto, CA (US)

(73) Assignee: Alipay (Hangzhou) Information Technology Co., Ltd., Hangzhou (CN)

(21) Appl. No.: 18/542,118

(22) Filed: Dec. 15, 2023

Related U.S. Application Data
(63) Continuation of application No. PCT/CN2022/093628, filed on May 18, 2022.

(30) Foreign Application Priority Data
Jul. 23, 2021 (CN) 202110835599.0

(51) Int. Cl. G06N 20/00

(52) U.S. Cl. CPC G06N 20/00

(57) ABSTRACT

Embodiments of this specification provide methods, apparatuses systems, and computer-readable media for data privacy-preserving training of a service prediction model. In an example training process, a member device performs prediction by using the service prediction model and object feature data held by the member device, and determines, by using a prediction result, update parameters used to update model parameters, where the update parameters include sub-parameters for computational layers of the service prediction model; and divides the computational layers into first-type and second-type computational layers using the sub-parameters; and performs privacy processing on sub-parameters of the first-type computational layers, and outputs processed sub-parameters. Processed sub-parameters of member devices can be aggregated into aggregated sub-parameters. The member device can obtain aggregated sub-parameters of the first-type computational layers, and updates the model parameters by using the aggregated sub-parameters and sub-parameters of the second-type computational layers.

### CROSS-REFERENCE TO RELATED APPLICATIONS

This application is a continuation of PCT Application No. PCT/CN2022/093628, filed on May 18, 2022, which claims priority to Chinese Patent Application No. 202110835599.0, filed Jul. 23, 2021, all of which is hereby incorporated by reference in their entireties.

### TECHNICAL FIELD

One or more embodiments of this specification relate to the field of privacy preserving technologies, and in particular, to methods and apparatuses for data privacy-preserving training of service prediction models.

### BACKGROUND

With the development of artificial intelligence technologies, neural networks have been gradually applied to fields such as risk assessment, voice recognition, facial recognition, and natural language processing. Neural network structures in different application scenarios have been relatively fixed. To implement better model performance, more training data are needed. In the medical and financial fields, different enterprises or institutions have different data samples. Once the data are used for joint training, model accuracy is greatly improved. However, data samples owned by different enterprises or institutions generally include a large amount of private information. Once the information is leaked, irreparable negative impact may be caused. As such, in the scenario of multi-party joint training to address the issue of data silos, preserving of data privacy has become a focus of research in recent years.

Therefore, it is expected that there can be an improved solution to improve preserving of privacy data of all parties during multi-party joint training

### SUMMARY

One or more embodiments of this specification describe methods and apparatuses for data privacy-preserving training of a service prediction model, to improve preserving of privacy data of all parties during multi-party joint training Specific technical solutions are as follows:

According to a first aspect, embodiments provide a method for data privacy-preserving training of a service prediction model, where a server and a plurality of member devices perform joint training, the service prediction model includes a plurality of computational layers, and the method is performed by any member device and includes: performing prediction by using the service prediction model and object feature data that are of a plurality of objects and that are held by the member device, and determining, by using a prediction result of an object, update parameters associated with the object feature data, where the update parameters are used to update model parameters, and include a plurality of sub-parameters for the plurality of computational layers; dividing the plurality of computational layers into first-type computational layers and second-type computational layers by using the plurality of sub-parameters, where sub-parameter values of the first-type computational layers fall within a specified range, and sub-parameter values of the second-type computational layers fall outside the specified range; performing privacy processing on sub-parameters of the first-type computational layers, and outputting processed sub-parameters; obtaining aggregated sub-parameters of the first-type computational layers, where the aggregated sub-parameters are obtained through aggregation based on processed sub-parameters of at least two member devices, and are associated with object feature data of the at least two member devices; and updating the model parameters by using the aggregated sub-parameters and sub-parameters of the second-type computational layers.

In implementations, the update parameters are implemented based on a model parameter gradient or a model parameter difference, and the model parameter gradient is determined based on a prediction loss obtained in current training; and the model parameter difference is determined according to the following method: obtaining initial model parameters in current training and a model parameter gradient obtained in current training; updating the initial model parameters by using the model parameter gradient, to obtain simulated update parameters; and determining the model parameter difference based on a difference between the initial model parameters and the simulated update parameters.

In implementations, the steps of performing prediction by using the service prediction model, and determining, by using a prediction result of an object, update parameters associated with the object feature data include: inputting the object feature data of the object into the service prediction model, and processing the object feature data by using the plurality of computational layers that include the model parameters in the service prediction model, to obtain the prediction result of the object; determining a prediction loss based on a difference between the prediction result of the object and label information of the object; and determining, based on the prediction loss, the update parameters associated with the object feature data.

In implementations, the steps of dividing the plurality of computational layers into first-type computational layers and second-type computational layers include: determining a plurality of sub-parameter representation values corresponding respectively to the plurality of sub-parameters by using vector elements included in the sub-parameters, where a sub-parameter representation value is used to represent a value of a corresponding sub-parameter; and dividing the plurality of computational layers into the first-type computational layers and the second-type computational layers by using the plurality of sub-parameter representation values.

In implementations, the sub-parameter representation value is implemented by using one of the following values: a norm value, a mean value, a variance value, a standard deviation value, a maximum value, a minimum value, or a difference between a maximum value and a minimum value.

In implementations, the sub-parameter representation values of the first-type computational layers are greater than the sub-parameter representation values of the second-type computational layers.

In implementations, the specified range includes that orders of magnitude of the plurality of sub-parameter values fall within a predetermined magnitude range.

In implementations, the step of performing privacy processing on the sub-parameters of the first-type computational layers includes: determining noise data for the sub-parameters of the first-type computational layers based on an (ϵ, δ)-differential privacy algorithm; and separately combining the noise data with corresponding sub-parameters of the first-type computational layers to obtain corresponding processed sub-parameters.

In implementations, the step of determining noise data for the sub-parameters of the first-type computational layers includes: calculating a noise variance value of Gaussian noise by using differential privacy parameters ϵ and δ; and generating, based on the noise variance value, corresponding noise data for vector elements included in the sub-parameters of the first-type computational layers.

In implementations, before the separately combining the noise data with corresponding sub-parameters of the first-type computational layers, further including: determining, by using several sub-parameters corresponding to the first-type computational layers, an overall representation value used to identify the sub-parameters of the first-type computational layers; and performing numerical clipping on the sub-parameters of the first-type computational layers by using the overall representation value and a predetermined clipping parameter, to obtain corresponding clipped sub-parameters; and the step of separately combining the noise data with corresponding sub-parameters of the first-type computational layers includes: separately combining the noise data with the corresponding clipped sub-parameters of the first-type computational layers.

In implementations, the step of updating the model parameters includes: performing numerical clipping on the sub-parameters of the second-type computational layers by using the overall representation value and the predetermined clipping parameter, to obtain corresponding clipped sub-parameters; and updating the model parameters by using the aggregated sub-parameters and the clipped sub-parameters of the second-type computational layers.

In implementations, the method further includes: obtaining object feature data of an object to be predicted after the service prediction model is trained; and determining a prediction result of the object to be predicted by using the object feature data of the object to be predicted and the trained service prediction model.

In implementations, the plurality of computational layers trained in the member device are all or some computational layers of the service prediction model.

In implementations, the object includes one of a user, a product, a transaction, and an event; the object feature data include at least one of the following feature groups: basic attribute features of the object, historical behavior features of the object, association relationship features of the object, interaction features of the object, and physical indicators of the object.

In implementations, the service prediction model is implemented by using a deep neural network (DNN), a convolutional neural network (CNN), a recurrent neural network (RNN), or a graph neural network (GNN).

According to a second aspect, embodiments provide a method for data privacy-preserving training of a service prediction model, where a server and a plurality of member devices perform joint training, the service prediction model includes a plurality of computational layers, and the method includes: separately performing, by the plurality of member devices, prediction by using the service prediction model and object feature data that are of a plurality of objects and that are respectively held by the plurality of member devices, and determining, by using a prediction result of an object, update parameters associated with the object feature data, where the update parameters are used to update model parameters, and include a plurality of sub-parameters for the plurality of computational layers; separately dividing, by the plurality of member devices, the plurality of computational layers into first-type computational layers and second-type computational layers by using the plurality of sub-parameters, where sub-parameter values of the first-type computational layers fall within a specified range, and sub-parameter values of the second-type computational layers fall outside the specified range; separately performing, by the plurality of member devices, privacy processing on the sub-parameters of the first-type computational layers, and separately sending obtained processed sub-parameters to the server; performing, by the server, aggregation for the computational layers based on processed sub-parameters sent by at least two member devices, to obtain aggregated sub-parameters corresponding respectively to the first-type computational layers, and sending the aggregated sub-parameters to a corresponding member device; and separately receiving, by the plurality of member devices, the aggregated sub-parameters sent by the server, and updating the model parameters by using the aggregated sub-parameters and sub-parameters of the second-type computational layers.

According to a third aspect, embodiments provide an apparatus for data privacy-preserving training of a service prediction model, where a plurality of member devices perform joint training, the service prediction model includes a plurality of computational layers, and the apparatus is disposed in any member device and includes: a parameter determining module, configured to perform prediction by using the service prediction model and object feature data that are of a plurality of objects and that are held by the member device, and determine, by using a prediction result of an object, update parameters associated with the object feature data, where the update parameters are used to update model parameters, and include a plurality of sub-parameters for the plurality of computational layers; a computational layer division module, configured to divide the plurality of computational layers into first-type computational layers and second-type computational layers by using the plurality of sub-parameters, where sub-parameter values of the first-type computational layers fall within a specified range, and sub-parameter values of the second-type computational layers fall outside the specified range; a privacy processing module, configured to perform privacy processing on the sub-parameters of the first-type computational layers, and output processed sub-parameters; a parameter aggregation module, configured to obtain aggregated sub-parameters of the first-type computational layers, where the aggregated sub-parameters are obtained through aggregation based on processed sub-parameters of at least two member devices, and are associated with object feature data of the at least two member devices; and a model update module, configured to update the model parameters by using the aggregated sub-parameters and sub-parameters of the second-type computational layers.

In implementations, the update parameters are implemented based on a model parameter gradient or a model parameter difference, and the model parameter gradient is determined based on a prediction loss obtained in current training; and the apparatus further includes a difference determining module, configured to determine the model parameter difference according to the following method: obtaining initial model parameters in current training and a model parameter gradient obtained in current training; updating the initial model parameters by using the model parameter gradient, to obtain simulated update parameters; and determining the model parameter difference based on a difference between the initial model parameters and the simulated update parameters.

In implementations, the computational layer division module is specifically configured to determine a plurality of sub-parameter representation values corresponding respectively to the plurality of sub-parameters by using vector elements included in the sub-parameters, where a sub-parameter representation value is used to represent a value of a corresponding sub-parameter; and divide the plurality of computational layers into the first-type computational layers and the second-type computational layers by using the plurality of sub- parameter representation values.

In implementations, the privacy processing module is specifically configured to determine noise data for the sub-parameters of the first-type computational layers based on an (ϵ, δ)-differential privacy algorithm; and separately combine the noise data with corresponding sub-parameters of the first-type computational layers to obtain corresponding processed sub-parameters.

According to a fourth aspect, embodiments provide a system for data privacy-preserving training of a service prediction model, including a plurality of member devices, where the service prediction model includes a plurality of computational layers, where the plurality of member devices are configured to separately perform prediction by using the service prediction model and object feature data that are of a plurality of objects and that are respectively held by the plurality of member devices, and determine, by using a prediction result of an object, update parameters associated with the object feature data, where the update parameters are used to update model parameters, and include a plurality of sub-parameters for the plurality of computational layers; separately divide the plurality of computational layers into first-type computational layers and second-type computational layers by using the plurality of sub-parameters, where sub-parameter values of the first-type computational layers fall within a specified range, and sub-parameter values of the second-type computational layers fall outside the specified range; separately perform privacy processing on the sub-parameters of the first-type computational layers, and output processed sub-parameters; and separately obtain aggregated sub-parameters of the first-type computational layers, and update the model parameters by using the aggregated sub-parameters and sub-parameters of the second-type computational layers, where the aggregated sub-parameters are obtained through aggregation based on processed sub-parameters of at least two member devices, and are associated with object feature data of the at least two member devices.

According to a fifth aspect, embodiments provide a computer-readable storage medium, storing a computer program, where when the computer program is executed in a computer, the computer is enabled to perform the method according to either of the first aspect and the second aspect.

According to a sixth aspect, embodiments provide a computing device, including a memory and a processor, where the memory stores executable code, and when executing the executable code, the processor implements the method according to either of the first aspect and the second aspect.

According to the methods and the apparatuses provided in the embodiments of this specification, a plurality of member devices jointly train a service prediction model. Any member device performs prediction on object feature data by using the service prediction model; determines, by using a prediction result, update parameters used to update model parameters; divides a plurality of computational layers by using a plurality of sub-parameters in the update parameter; performs privacy processing on the sub-parameters of first-type computational layers, and outputs processed sub-parameters; obtains aggregated sub-parameters of the first-type computational layers; and updates the model parameters by using the aggregated sub-parameters and sub-parameters of second-type computational layers. The member device performs privacy processing on the first-type sub-parameters, to avoid outputting plaintext of the privacy data. The processed sub-parameters sent by the plurality of member devices are aggregated, so that discrete data are converted into aggregated data, and each member device that receives the aggregated data can also implement joint training on the service prediction model. In addition, privacy data of the member device is not leaked to another member device in this process, so that the privacy data of the member device are well preserved.

### BRIEF DESCRIPTION OF DRAWINGS

FIG. 1A is a schematic diagram illustrating an implementation architecture, according to an embodiment disclosed in this specification;

FIG. 1B is a schematic diagram illustrating an implementation architecture, according to another embodiment;

FIG. 2 is a schematic flowchart illustrating a method for data privacy-preserving training of a service prediction model, according to an embodiment;

FIG. 3 is a schematic diagram illustrating a process of separately processing a plurality of computational layers in a certain member device;

FIG. 4 is another schematic flowchart illustrating a method for data privacy-preserving training of a service prediction model, according to an embodiment;

FIG. 5 is a schematic block diagram illustrating an apparatus for data privacy-preserving training of a service prediction model, according to an embodiment; and

FIG. 6 is a schematic block diagram illustrating a system for data privacy-preserving training of a service prediction model, according to an embodiment.

### DESCRIPTION OF EMBODIMENTS

The solutions provided in this specification are described below with reference to the accompanying drawings.

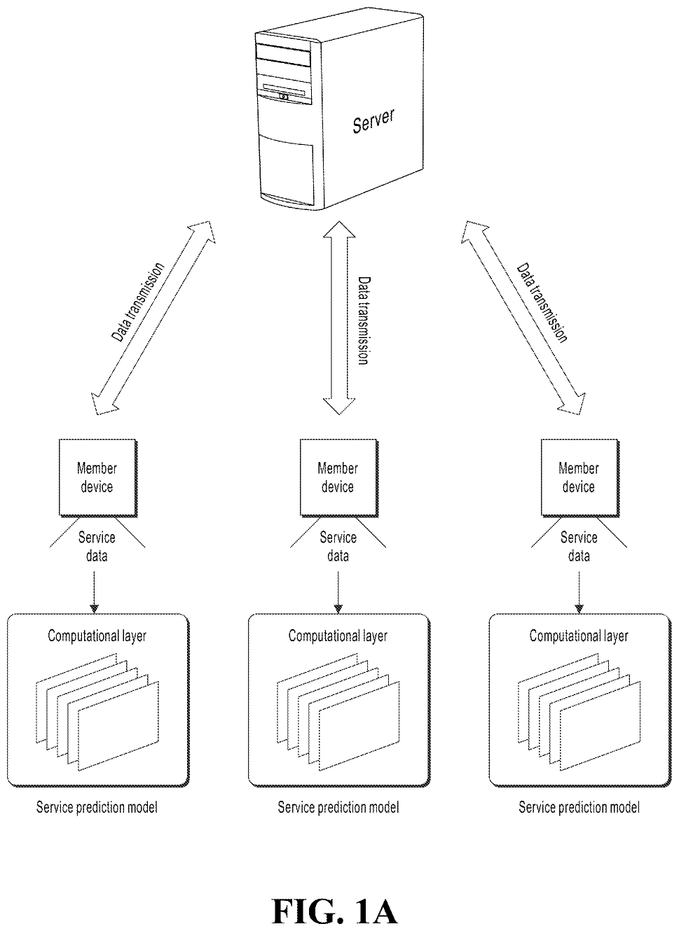

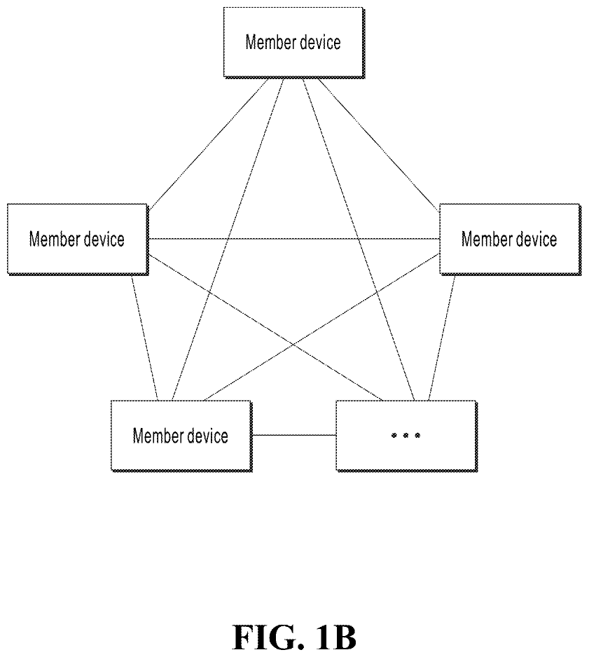

FIG. 1A is a schematic diagram illustrating an implementation architecture, according to an embodiment disclosed in this specification. A server is separately communicatively connected to a plurality of member devices, and can perform data transmission with the member devices. A quantity N of the plurality of member devices can be 2 or a natural number greater than 2. The communicative connection can be a connection through a local area network, or can be a connection through a public network. The member devices can have their respective service data. The plurality of member devices jointly train a service prediction model by exchanging data with the server. The service prediction model trained in this method uses service data of all the member devices as data samples, and model performance and robustness obtained through training are also better.

A client-server architecture formed by the server and at least two member devices is a specific implementation of joint training. In practice, joint training can alternatively be implemented by using a peer-to-peer network architecture. The peer-to-peer network architecture includes at least two member devices, and does not include the server. In this network architecture, the plurality of member devices jointly train the service prediction model in a predetermined data transmission method. FIG. 1B is a schematic diagram illustrating an implementation architecture, according to another embodiment. The plurality of member devices are directly communicatively connected to each other, and perform data transmission with each other.

Service data in the member device are privacy data, and cannot be sent, to the outside, from an internal secure environment where the member device is located. Various parameters that are obtained based on the service data and that include the privacy data cannot be sent to the outside in plaintext. In conclusion, during existing multi-member joint model training, a primary technical problem to be resolved is to minimize leakage of the privacy data.

The member devices can correspond respectively to different service platforms, and different service platforms perform data transmission with the server by using computer devices of the service platforms. The service platform can be a bank, a hospital, a physical examination institution, or another institution or organization, and these participants perform joint model training by using devices of the participants and service data owned by the participants. Different member devices represent different service platforms.

Then, the service prediction model to be trained is described. The service prediction model can be used to process input object feature data by using a model parameter, to obtain a prediction result. The service prediction model can include a plurality of computational layers. The plurality of computational layers are arranged in a specified sequence. An output of a current computational layer is used as an input of a subsequent computational layer. Feature extraction is performed on the object feature data by using the plurality of computational layers, and classification processing or regression processing is performed on an extracted feature to output a prediction result for an object. The computational layers include a model parameter.

During initial training, the plurality of member devices can obtain a plurality of computational layers of the service prediction model in advance, where the computational layers can include initial model parameters. The service prediction model can be delivered by the server to each member device, or can be manually configured. The initial model parameters can be respectively determined by the member devices. This embodiment sets no limitation on a quantity of computational layers of the service prediction model. The computational layer in the member device shown in FIG. 1A is merely a schematic diagram, and imposes no limitation on this application.

In an iteration process of performing joint model training by using service data of the plurality of member devices, to preserve security of privacy data of the member device, in any iterative training, the member device divides the plurality of computational layers by using sub-parameters, performs privacy processing on computational layers whose sub-parameter values fall within a specified range, outputs processed sub-parameters, and then obtains aggregated sub-parameters obtained by aggregating processed sub-parameters of at least two member devices. In the joint processing process, the sub-parameters that undergo privacy processing do not leak privacy data, and aggregation is performed on the sub-parameters that undergo privacy processing. Therefore, a data feature cannot be inferred based on the sub-parameters that undergo privacy processing, and aggregation processing is implemented on the parameters, so that data privacy is well preserved in a training process and a data exchange process.

The client-server architecture is used as an example below to describe this application with reference to a specific embodiment.

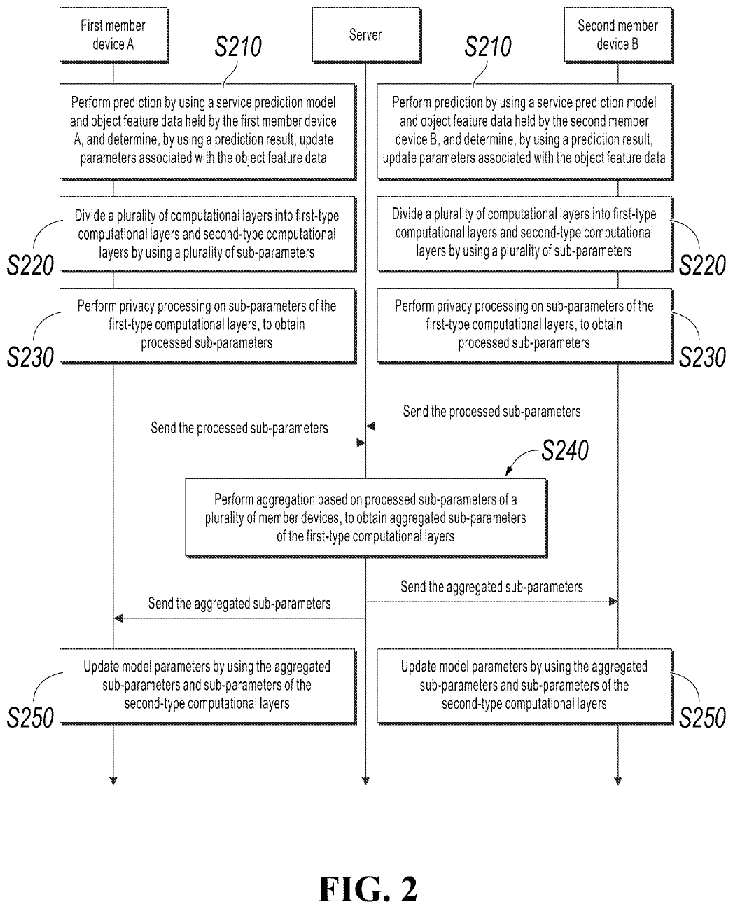

FIG. 2 is a schematic flowchart illustrating a method for data privacy-preserving training of a service prediction model, according to an embodiment. In the method, a server and a plurality of member devices perform joint training, and the server and the plurality of member devices each can be implemented by any apparatus, device, platform, device cluster, etc. having a computing and processing capability. For ease of description, two member devices are mainly used as an example below for description, for example, a first member device A and a second member device B are used for description. However, in practice, at least two member devices are mainly used for implementation. The service prediction model is represented by W, and service prediction models in different member devices are represented by corresponding subscripts of W. Joint training of the service prediction model W can include a plurality of iterative training processes. Any iterative training process is described below by using the following steps S210 to S250.

First, in step S210, the first member device A performs prediction by using a service prediction model WA and object feature data SA that are of a plurality of objects and that are held by the first member device A, and determines, by using a prediction result of an object, update parameters GA associated with the object feature data. The second member device B performs prediction by using a service prediction model WB and object feature data SB that are of a plurality of objects and that are held by the second member device B, and determines, by using a prediction result of an object, update parameters GB associated with the object feature data.

Object feature data S held by any member device (for example, the first member device A or the second member device B) are service data of a corresponding service platform and are privacy data. The object feature data S can be directly stored in the member device, or can be stored in a high-availability storage device. When needed, the member device can be read from the high-availability storage device. The high-availability storage device can be located in an internal network of the service platform, or can be located in an external network. For security, the object feature data S are stored in a ciphertext form.

Object feature data S that are of a plurality of objects and that are held by any member device can exist in a training set. Object feature data S of any object are one piece of service data, and is also one piece of sample data. The object feature data S can be represented in a form of a feature vector.

Due to diversity of the service platform and diversity of service types of the service platform, the object and the object feature data of the object can include a plurality of specific forms and content. For example, the object can be one of a user, a product, a transaction, and an event. The object feature data can include at least one of the following feature groups: basic attribute features of the object, historical behavior features of the object, association relationship features of the object, interaction features of the object, and physical indicators of the object.

When the object is a user, the object feature data are user feature data, and include basic attribute features such as age, gender, registration length, and an education level of the user, historical behavior features such as a recent browsing history and a recent shopping history, association relationship features such as a product and another user in an association relationship with the user, interaction features such as clicking and viewing by the user on a page, and information about physical indicators such as a blood pressure value, a blood sugar value, and a body fat percentage of the user.

When the object is a product, the object feature data are product feature data, and include basic attribute features such as a category, an origin, ingredients, and a process of the product, association relationship features such as a user, a shop, or another product in an association relationship with the product, and historical behavior features such as purchase, transfer, and return of the product.

When the object is a transaction, the object feature data are transaction feature data, and include features such as a number, an amount, a payee, a payer, and a payment time of the transaction.

When the object is an event, the event can include a login event, a purchase event, a social event, etc. Basic attribute information of the event can be textual information used to describe the event, association relationship information can include text that has a relationship with the event in context, information about another event that has an association with the event, etc., and historical behavior information can include record information of development and a change of the event in the time dimension.

That any member device performs prediction by using a service prediction model W and determines, by using a prediction result of an object, update parameters G associated with object feature data can specifically include steps 1 to 3:

Step 1. Input object feature data S of an object into a service prediction model W, and process the object feature data S by using a plurality of computational layers that include model parameters in the service prediction model W, to obtain a prediction result of an object. Step 2. Determine a prediction loss based on a difference between the prediction result of the object and label information of the object. Step 3. Determine, based on the prediction loss, update parameters G associated with the object feature data S.

In a user risk detection scenario, the object can be a user, and the service prediction model is implemented as a risk detection model. The risk detection model is used to process input user feature data to obtain a prediction result indicating whether the user is a high-risk user. In this scenario, a sample feature is user feature data, and sample label information is, for example, whether the user is a high-risk user.

In a specific model training process, the user feature data can be input into the risk detection model, and the user feature data are processed by using a plurality of computational layers in the risk detection model to obtain a classification prediction result indicating whether the user is a high-risk user. A prediction loss is determined based on a difference between the classification prediction result and the sample label information that includes whether the user is a high-risk user. Update parameters associated with the user feature data are determined based on the prediction loss, where the update parameters include related information in the user feature data.

In the user risk detection scenario, different service platforms include different service data of the user. How to determine which users are high-risk users based on a large quantity of user account operations is a technical problem to be resolved for the risk detection model. User feature data of a plurality of service platforms are used for joint training, so that a sample quantity of high-risk samples can be effectively increased, and performance of the risk detection model can be improved, thereby effectively distinguishing which users are high-risk users.

In a medical evaluation scenario, the object can be a drug, and drug feature data can include function information and application range information of the drug, related physical indicator data of a patient before and after using the drug, basic attribute features of the patient, etc. The service detection model is implemented as a drug evaluation model. The drug evaluation model is used to process the input drug feature data to obtain an effect evaluation result of the drug. In this scenario, sample label information is, for example, a drug effective value labeled based on the related physical indicator data of the patient before and after using the drug.

In a specific model training process, the drug feature data can be input into the drug evaluation model, and the drug feature data are processed by using a plurality of computational layers in the drug evaluation model to obtain a prediction result, where the prediction result includes a drug effective value of the drug on a condition of the patient. A prediction loss is determined based on a difference between the prediction result and the drug effective value of the label information. Update parameters associated with the drug feature data are determined based on the prediction loss, where the update parameters include related information in the drug feature data.

In the drug risk detection scenario, the service platform can be a plurality of hospitals. An actual effective value of a certain drug after the drug is put into use is a technical problem to be resolved for the drug evaluation model. When a limited quantity of patients use the drug in a certain hospital, joint model training is performed by using patient data from a plurality of hospitals, so that a sample quantity can be effectively increased, and sample types can be enriched. As such, the drug evaluation model is more accurate, to determine drug effectiveness more accurately.

The above-mentioned service prediction model W can be used as a feature extraction model, and is used to perform feature extraction on the input object feature data S to obtain a deep feature of the object. Any member device can input object feature data of an object into the service prediction model W, and determine a deep feature of the object by using the service prediction model W. The member device inputs the deep feature into a classifier to obtain a classification prediction result, or performs regression processing on the deep feature to obtain a regression prediction result. The prediction result obtained by using the service prediction model W can include a classification prediction result or a regression prediction result.

The above-mentioned service prediction model W can alternatively include a feature extraction layer and a classification layer, or include a feature extraction layer and a regression layer. The member device inputs the object feature data S into the service prediction model W. The service prediction model W outputs a classification prediction result or a regression prediction result, and the member device can obtain the classification prediction result or the regression prediction result.

The service prediction model can be implemented by using a deep neural network (DNN), a convolutional neural network (CNN), a recurrent neural network (RNN), or a graph neural network (GNN).

In step S210, the update parameters G are used to update model parameters, where the update parameters include a plurality of sub-parameters Gⱼ for a plurality of computational layers, and j is a number of the computational layer. For example, when there are 100 computational layers, a value of j can be 0 to 99.

Specifically, the update parameters G can be implemented based on a model parameter gradient G1 or a model parameter difference G2. The model parameter gradient G1 is determined based on a prediction loss obtained in current training. For example, a backpropagation method can be used to determine a plurality of sub-parameters of the plurality of computational layers based on the prediction loss.

There are a plurality of types of backpropagation algorithms, for example, optimizer algorithms such as Adam, gradient descent with momentum, RMSprop, and SGD. When optimizers such as Adam, gradient descent with momentum, and RMSprop are used, an update effect obtained when the model parameter gradient is used as the update parameters and an update effect obtained when the model parameter difference is used as the update parameters are different for the model parameters. When an optimizer algorithm such as SGD is used, the model parameter gradient and the model parameter difference have a same update effect for the model parameters.

In any iterative training process for the service prediction model, the model parameter difference can be determined according to the following method: obtaining initial model parameters in current training and a model parameter gradient obtained in current training; updating the initial model parameters by using the model parameter gradient, to obtain simulated update parameters; and determining the model parameter difference based on a difference between the initial model parameters and the simulated update parameters.

The initial model parameters in current training are model parameters of the service prediction model W in the above-mentioned step 1, and the initial model parameters are not updated in current training. The model parameter gradient obtained in current training can be a model parameter gradient determined based on the prediction loss in step 3.

When current training is the first time of training, the initial model parameters can be predetermined values or randomly determined values. When current training is not the first time of training, the initial model parameters are obtained by updating the model parameters by using an aggregated model parameter difference in the previous training The server implements an aggregation operation on the model parameter difference. For a specific implementation process, references can be made to a subsequent process in this embodiment.

The initial model parameters are updated by using the model parameter gradient, to obtain simulated update parameters. The simulated update parameters are not actually applied to the service prediction model W. A reason is as follows: In an update process of the simulated update parameters, object feature data of another member device are not incorporated. Instead, the simulated parameters are obtained through training only based on service data of a current member device.

Next, a representation form of the update parameters is described. The service prediction model W includes a plurality of computational layers, any computational layer includes corresponding model parameters, and the model parameters of the computational layer can be represented by using a vector or a matrix. Therefore, the model parameter differences of all the computational layers can also be represented by using a matrix or a matrix set.

When the model parameter gradient is determined based on the prediction loss, a model parameter gradient (that is, a sub-parameter) of each computational layer can be determined. The model parameter gradient of any computational layer is represented by using a matrix, and the model parameter gradients of all the computational layers can be represented by using a matrix set.

Therefore, regardless of whether the update parameters G are implemented based on the model parameter gradient G1 or the model parameter difference G2, the update parameters G can be a matrix set, and the sub-parameter Gⱼ of each computational layer can be a matrix or a vector. For ease of description, subsequently, a sub-parameter of the first member device A is represented as G_{Aj}, and a sub-parameter of the second member device B is represented as G_{Bj}.

Next, in step S220, the first member device A divides the plurality of computational layers into first-type computational layers and second-type computational layers by using the plurality of sub-parameters G_{Aj}, and the second member device B divides the plurality of computational layers into first-type computational layers and second-type computational layers by using the plurality of sub-parameters G_{Bj}.

Sub-parameter values of the first-type computational layers fall within a specified range, and sub-parameter values of the second-type computational layers fall outside the specified range. The specified range can include that orders of magnitude of the plurality of sub-parameter values fall within a predetermined magnitude range, or differences between the plurality of sub-parameter values fall within a predetermined difference range. One of the two conditions can be used, or the two conditions can be used in combination. When the two conditions are used in combination, the first-type computational layers need to satisfy both of the two conditions, or need to satisfy only one of the two conditions.

The predetermined magnitude range [a, b] can be predetermined. The predetermined magnitude range can include one magnitude. In this case, a=b. That is, the order of magnitude of the plurality of sub-parameter values is at a same magnitude. The predetermined magnitude range [a, b] can alternatively include a plurality of magnitudes. In this case, a is not equal to b. That is, [a, b] includes a plurality of values, that is, the orders of magnitude of the plurality of sub-parameter values fall within a range of a plurality of magnitudes, and the plurality of magnitudes are generally consecutive magnitudes. The magnitude can also be understood as a multiple, and the plurality of sub-parameter values can be different, but multiples between the plurality of sub-parameter values fall within a specific multiple range. In this case, computational layers corresponding to such sub-parameter values can be classified into the first-type computational layers. If the plurality of sub-parameter values exceed the multiple range, computational layers corresponding to such sub-parameter values are classified into the second-type computational layers.

The predetermined difference range [c, d] can be predetermined. The sub-parameter values of the first-type computational layers fall within the predetermined difference range [c, d], and differences between sub-parameters of the second-type computational layers falls outside the predetermined difference range [c, d].

In conclusion, values of the sub-parameters of the first-type computational layers are similar to each other, and their magnitudes are relatively consistent, and values of the sub-parameters of the second-type computational layers are relatively different compared with the values of the sub-parameters of the first-type computational layers. Optionally, the values of the sub-parameters of the first-type computational layers are greater than the values of the sub-parameters of the second-type computational layers. For example, an order of magnitude of the sub-parameter values of the first-type computational layers is 10000, 100000, and an order of magnitude of the sub-parameter values of the second-type computational layers is 10, 100. A computational layer with a larger sub-parameter value contributes more to federated aggregation. Therefore, compared with a computational layer with a smaller sub-parameter value, the computational layer with a larger sub-parameter value is selected as the first-type computational layer to perform federated aggregation described later.

The sub-parameters can be a value, or can be a matrix or a vector that includes a plurality of elements.

For any member device, when the sub-parameters are a value, the plurality of computational layers can be directly divided based on values of the plurality of sub-parameters. When the sub-parameters are a matrix or a vector, and the plurality of computational layers are divided, a plurality of sub-parameter representation values corresponding respectively to the plurality of sub-parameters can be determined by using vector elements included in the sub-parameters, and the plurality of computational layers are divided into the first-type computational layers and the second-type computational layers by using the plurality of sub-parameter representation values. A sub-parameter representation value is used to represent a value of a corresponding sub-parameter.

Because the sub-parameters are in a form of a matrix or a vector, it is not easy to directly compare differences between a plurality of sub-parameters. The sub-parameter representation value is used to represent a value of the sub-parameter, so that it is relatively easy to compare values of the sub-parameters.

Specifically, the sub-parameter representation value can be calculated by using a norm value, a mean value, a variance value, a standard deviation value, a maximum value, a minimum value, or a difference between a maximum value and a minimum value. More specifically, the sub-parameter representation value can be used to determine the sub-parameter representation value based on an absolute value of the vector element included in the sub-parameters by using a norm value, a mean value, a variance value, a standard deviation value, a maximum value, a minimum value, or a difference between a maximum value and a minimum value. The norm value is used as an example below for description. Any member device can calculate the sub-parameter representation value by using the vector elements g₁, g₂, . . . , and gₖ included in a vector representing the sub-parameters and the Euclidean norm (L2 norm). For example, calculation can be performed by using the following equation:

$${L}_{j} = \sqrt{{\sum }_{k} {( {g}_{k} )}^{2}}$$

Where Lⱼ is a sub-parameter representation value of a j^{th} computational layer, gₖ is a k^{th} element in a vector representing the sub-parameters of the j^{th} computational layer, and a summation symbol means summing up values of k. Calculating the sub-parameter representation value by using the L2 norm means obtaining a square root of the sum of squares of vector elements in the vector representing the sub-parameters. The sub-parameter representation value can alternatively be calculated by using an L0 norm or an L1 norm. Details are omitted here for simplicity.

When the sub-parameter representation value is represented by using a mean value, a variance value, or a standard deviation value, etc., the sub-parameter representation value can alternatively be calculated by using a corresponding equation based on the vector elements included in the sub-parameter. Details are omitted here for simplicity. When the sub-parameter representation value is determined by using a maximum value, a minimum value, or a difference between a maximum value and a minimum value, the maximum value can be a maximum value of absolute values of the vector elements included in the sub-parameter, and the minimum value can be a minimum value of absolute values of the vector elements included in the sub-parameter, or the difference between the maximum value and the minimum value can be determined, and the difference is used as the sub-parameter representation value.

When the plurality of computational layers are divided by using the plurality of sub-parameter representation values, the specified range can be set for the sub-parameter representation value. For example, the specified range can include that orders of magnitude of the plurality of sub-parameter representation values fall within a predetermined magnitude range, or differences between the plurality of sub-parameter representation values fall within a predetermined difference range. During use, one of the two conditions can be used, or both the two conditions can be used.

When specifically dividing the plurality of computational layers, the member device can separately determine a multiple between sub-parameter representation values of any two computational layers to obtain a plurality of multiples, classify two computational layers with a multiple falling within the predetermined magnitude range [a, b] into the first-type computational layers, and classify remaining computational layers into the second-type computational layers. Certainly, there are many other methods for dividing the computational layers, provided that the computational layers can be divided into two types of computational layers that satisfy the above-mentioned condition.

Because the member devices separately divide the computational layers based on the sub-parameters of the member devices, division results of different member devices may be different. For example, the first-type computational layers of the first member device A include computational layers 1, 2, 3, 5, and 6, and the second-type computational layers of the first member device include computational layers 4, 7, 8, 9, and 10. The first-type computational layers of the second member device B include computational layers 1, 3, 5, and 6, and the second-type computational layers of the second member device include computational layers 2, 4, 7, 8, 9, and 10. Quantities and types of computational layers included in the first-type computational layers of different member devices can be different, or certainly can be the same.

A computational layer division result of any member device is affected by object feature data of the member device. Different object feature data may lead to different computational layer division results. The computational layer division result is associated with an intrinsic feature of the object feature data.

Generally, a larger or smaller model parameter gradient or model parameter difference causes overfitting of the model parameters. The computational layers of the member device are divided based on the value of the sub-parameter, so that a larger or smaller model parameter gradient or model parameter difference can be prevented from being shared with another member device, and a factor that may lead to overfitting can also be prevented from being added to the model parameters in joint model training.

In step S230, the first member device A performs privacy processing on the sub-parameters of the first-type computational layers to obtain processed sub-parameters, and sends the processed sub-parameters to the server. The second member device B performs privacy processing on the sub-parameters of the first-type computational layers to obtain processed sub-parameters, and sends the processed sub-parameters to the server.

The server receives the processed sub-parameters sent by the first member device A, and receives the processed sub-parameters sent by the second member device B. The processed sub-parameters include sub-parameters that are of several computational layers and that undergo privacy processing. The processed sub-parameters of the first member device A and the second member device B are different, for example, relate to different computational layers. When a same computational layer exists, sub-parameters of the same computational layer of the first member device A and the second member device B are also different.

To preserve privacy data of the member device, the sub-parameters need to be sent to the server after privacy processing. The privacy processing needs to be performed, so that no privacy data are leaked, and data obtained after the server performs aggregation can be directly used by the member device.

In implementations, any member device can determine noise data for the sub-parameters of the first-type computational layers based on an (ϵ, δ)-differential privacy algorithm, and separately combine the noise data with corresponding sub-parameters of the first-type computational layers to obtain corresponding processed sub-parameters. That is, noise for implementing differential privacy can be added to the sub-parameter, to implement privacy processing on the sub-parameter, for example, privacy processing can be implemented in a method such as Laplace noise or Gaussian noise. The differential privacy algorithm is used to add specific noise data to the sub-parameter, so that the sub-parameters of the member device can be preserved against privacy leakage, and impact of privacy processing on the data can be minimized.

ϵ is a privacy budget of the differential privacy algorithm, and δ is a privacy error of the differential privacy algorithm. Ε and δ can be predetermined based on an empirical value.

In an embodiment, Gaussian noise is used as an example. Any member device can calculate a noise variance value of Gaussian noise by using the differential privacy parameters ϵ and δ; and generate, based on the noise variance value, corresponding noise data [symbol] for vector elements included in the sub-parameters of the first-type computational layers. A quantity of vector elements included in the sub-parameters is equal to a quantity of pieces of generated noise data.

Before the noise data [symbol] and the corresponding sub-parameters of the first-type computational layers are separately combined, the sub-parameters can be further clipped based on a clipping parameter C and a noise scaling coefficient η. The clipping parameter C can be predetermined, and the noise scaling coefficient η can be determined based on the sub-parameters of the first-type computational layers.

Specifically, any member device can determine, by using several sub-parameters corresponding to the first-type computational layers, an overall representation value used to identify the sub-parameters of the first-type computational layers, and perform numerical clipping on the sub-parameters of the first-type computational layers by using the overall representation value L_{η} and a predetermined clipping parameter C, to obtain corresponding clipped sub-parameters. Specifically, numerical clipping can be performed on the sub-parameters of the first-type computational layers by using a ratio of the clipping parameter C to the overall representation value L_{η}.

During combination, the noise data [symbol] and the corresponding clipped sub-parameters of the first-type computational layers are separately combined. For example, the combination operation can include summation.

It can be seen from the above-mentioned content that, in this method, the sub-parameters are clipped, and the clipped sub-parameters and the noise data are combined, so that differential privacy processing that satisfies Gaussian noise is implemented on the sub-parameters.

When numerical clipping is performed on the sub-parameters of the first-type computational layers, for example, the following processing can be performed:

$${G}_{C , j} = \frac{{G}_{j}}{max \{ 1 , \frac{C}{{L}_{η}} \}}$$

Where Gⱼ is a sub-parameter of a j^{th} computational layer and belongs to the first-type computational layers, G_{C,j} is a clipped sub-parameter, C is the clipping parameter and is a hyperparameter, L_{η} is the overall representation value, and max is a maximum function. That is, the sub-parameters can be scaled based on adjustment of the clipping parameter and a same ratio. For example, when C is less than or equal to L_{η}, the sub-parameters remain unchanged. When C is greater than L_{η}, the sub-parameters are scaled down based on a ratio of C/L_{η}. Noise data are added to the clipped sub-parameters to obtain the processed sub-parameters, for example,

G_{N, j}=G_{C, j}+ [symbol] (0, η²C²I)

Where G_{N,j} is the processed sub-parameter, [symbol] (0, σ²C²I) represents noise data whose probability density uses 0 as a mean and η²C²I as a distribution variance, η represents the above-mentioned noise scaling coefficient, and can be predetermined, or can be replaced with the overall representation value, C is the clipping parameter, I represents an indication function, and can be 0 or 1, for example, it can be set that I is 1 in an even-number training round and is 0 in an odd-number training round in a plurality of iterations of the training

A method for performing differential privacy processing on the sub-parameters by adding the noise data to the sub-parameters of the first-type computational layers is described above. In this embodiment, the first-type computational layers whose sub-parameter values fall within the specified range are selected from the plurality of computational layers, the sub-parameter values of these computational layers are relatively averaged, and there is no excessively large value or excessively small value. The noise data have less impact on such sub-parameter values, and the sub-parameters after aggregation are also closer to an aggregated value without adding noise, so that the sub-parameters after aggregation are more accurate. In addition, the sub-parameters of the first computational layers and the second computational layers are clipped by using the clipping parameter and the overall representation value based on a ratio, so that impact of larger sub-parameter data on the model parameters can be reduced.

In step S240, the server performs aggregation based on the processed sub-parameters of the plurality of member devices to obtain aggregated sub-parameters of the first-type computational layers, and sends the aggregated sub-parameters to the corresponding first member device A and the corresponding second member device B. The server separately performs aggregation for the processed sub-parameters of the computational layers to obtain aggregated sub-parameters corresponding respectively to the first-type computational layers, and sends the aggregated sub-parameters to the corresponding member device.

The first member device A receives the corresponding aggregated sub-parameters sent by the server, and the second member device B receives the corresponding aggregated sub-parameters sent by the server. The aggregated sub-parameters are associated with the object feature data of the plurality of member devices, and the aggregated sub-parameters include intrinsic features of the object feature data of the plurality of member devices.

When the server performs aggregation for the computational layers, for example, data sent by the first member device A include the processed sub-parameters of the computational layer 1, 3, 5, and 6, data sent by the second member device B include the processed sub-parameters of the computational layer 1, 2, 4, and 5, and data sent by a third member device C include processed sub-parameters of 3, 4, 5, and 6.

The server can determine, for each computational layer, processed sub-parameters of member devices corresponding to the computational layer, and aggregate the determined processed sub-parameters of the member devices to obtain aggregated sub-parameters of the computational layer. For example, for the computational layer 1, after the processed sub-parameters sent by the first member device A and the second member device B are received, the two processed sub-parameters can be aggregated to obtain aggregated sub-parameters of the computational layer 1. The same process is followed for another computational layer, and details are omitted here for simplicity. When sending the aggregated sub-parameters, the server can send the corresponding aggregated sub-parameters to a member device that participates in data aggregation of the computational layer. For example, the server can send aggregated sub-parameters of the computational layer 1 to the first member device A and the second member device B, but does not send the aggregated sub-parameters of the computational layer 1 to the third member device C.

The above-mentioned aggregation is aggregation of matrices or vectors. A specific aggregation method can include direct summation or weighted summation. In the weighted summation method, a weight of the processed sub-parameters can be a ratio of a sample quantity of a corresponding member device to a total sample quantity, and the total sample quantity is the sum of sample quantities of all member devices corresponding to processed sub-parameters received by the server for a certain computational layer. For example, in the above-mentioned example, for the computational layer 1, the processed sub-parameters sent by the first member device A and the second member device B are received, and a sample quantity n A and a sample quantity n_{B} of the member devices are received. When the processed sub-parameters are aggregated, n_{A}/(n_{A}+n_{B}) and n_{B}/(n_{A}+n_{B}) can be separately used as weights.

In addition to the above-mentioned ratios used as weights, the weight can also be calculated based on performance or accuracy of the service prediction model. The model performance can be determined by using an area under curve (AUC) algorithm.

A specific method for aggregating the processed sub-parameters by the server side is described above. It can be seen from the above-mentioned content that data such as a sample quantity, model performance, and accuracy can be further transmitted between the member device and the server, so that aggregation of the sub-parameters can be better implemented.

In step S250, the first member device A updates the model parameters by using the aggregated sub-parameters and the sub-parameters of the second-type computational layers, and the second member device B updates the model parameters by using the aggregated sub-parameters and the sub-parameters of the second-type computational layers. As such, the updated model parameters are associated with the object feature data of the plurality of member devices, so that the updated model parameters include the intrinsic features of the object feature data of the plurality of member devices.

When the sub-parameters of the first-type computational layers are clipped, any member device can also perform numerical clipping on the sub-parameters of the second-type computational layers by using the overall representation value L_{η} and the predetermined clipping parameter C, to obtain corresponding clipped sub-parameters, and update the model parameters by using the clipped sub-parameters of the second-type computational layers. For a specific clipping method, references can be made to descriptions in step S230. Details are omitted here for simplicity.

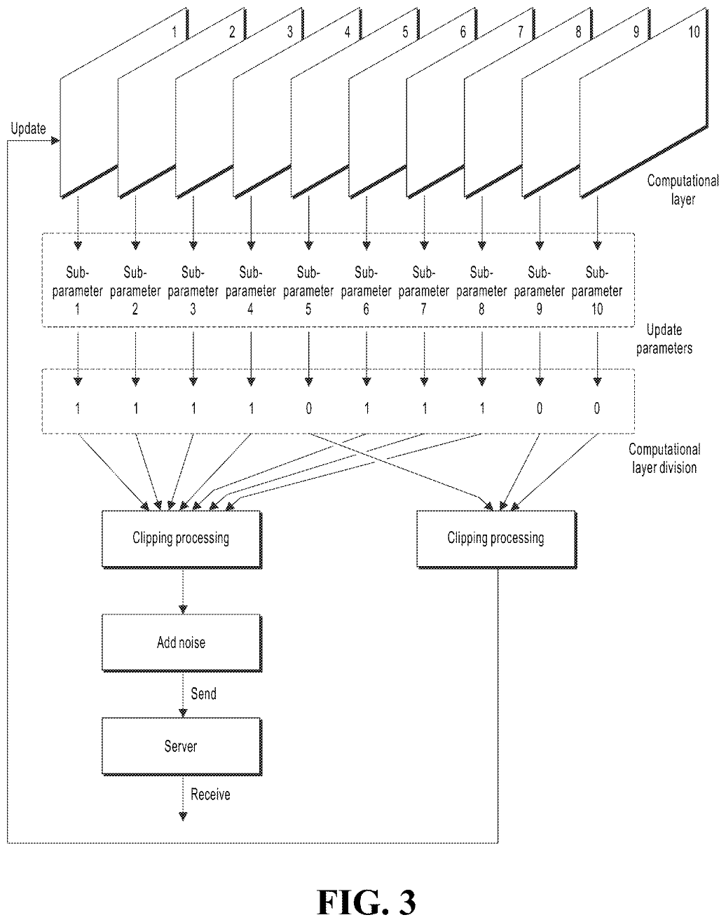

FIG. 3 is a schematic diagram illustrating a process of respectively processing a plurality of computational layers in a certain member device. The member device is any one of a plurality of member devices. Assume that a service prediction model of the member device includes 10 computational layers, each computational layer corresponds to one sub-parameter, and 10 sub-parameters form an update parameter. The computational layers can be divided into two parts by using the sub-parameters, one part is first-type computational layers, identified by 1, and the other part is second-type computational layers, identified by 0. Clipping processing is performed on sub-parameters of the first-type computational layers and the second-type computational layers. Then, noise is added to clipped sub-parameters of the first-type computational layers to implement differential privacy processing and obtain processed sub-parameters. Finally, the processed sub-parameters are sent to the server. The member device receives aggregated sub-parameters returned by the server, and updates model parameters in the computational layers by using the aggregated sub-parameters and clipped sub-parameters of the second-type computational layers.

For any member device, if the member device does not receive, for example, aggregated sub-parameters that are of a first computational layer and that are sent by the server, the first computational layer does not belong to the first-type computational layers, and the member device can directly update model parameters in the first computational layer by using sub-parameters that are of the first computational layer and that are obtained by the member device.

The above-mentioned steps S210 to S250 are one iterative training process. Based on the iterative training process, the service prediction model can be trained for a plurality of times until a predetermined convergence condition is satisfied. The convergence condition can be that a quantity of training times reaches a threshold, a loss value is less than a predetermined threshold, etc.

After the service prediction model is trained, the object feature data of the object to be predicted can be further obtained, and a prediction result of an object to be predicted is determined by using the trained service prediction model and the object feature data of the object to be predicted.

In a user risk detection scenario, object feature data of a user to be detected can be input into a risk detection model to obtain a prediction result indicating whether the user to be detected is a high-risk user.

In a medical evaluation scenario, object feature data of a drug to be detected can be input into a drug evaluation model to obtain drug effectiveness of the drug to be detected on a condition of a patient.

In an embodiment of this application, the plurality of trained computational layers in the member device can be all or some computational layers of the service prediction model.

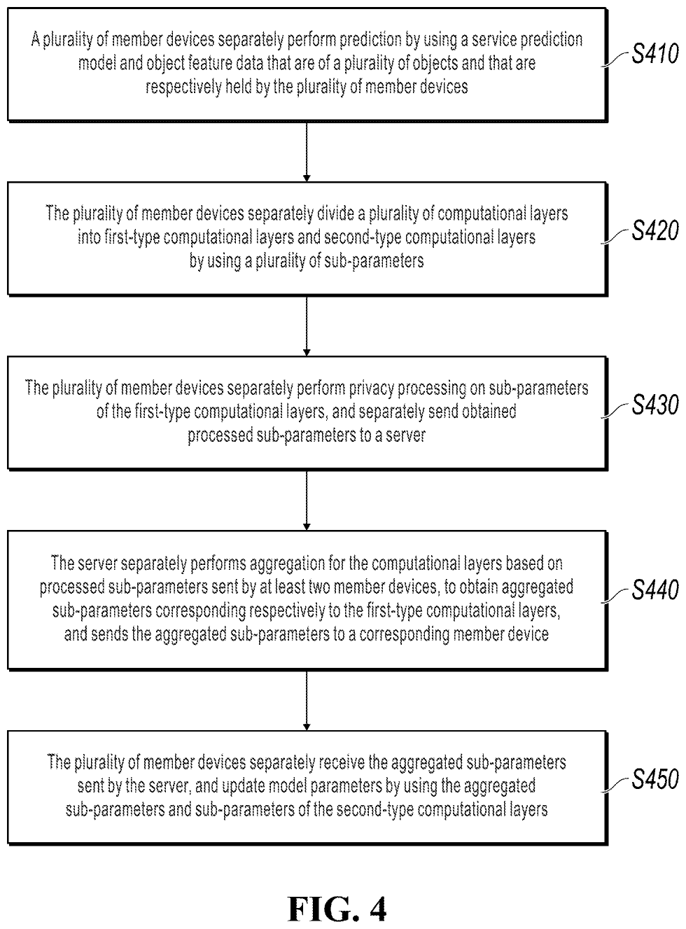

FIG. 4 is another schematic flowchart illustrating a method for data privacy-preserving training of a service prediction model, according to an embodiment. In the method, a server and a plurality of member devices perform joint training, the service prediction model includes a plurality of computational layers, and the method includes the following steps S410 to S450.

In step S410, the plurality of member devices separately perform prediction by using the service prediction model and object feature data that are of a plurality of objects and that are respectively held by the plurality of member devices, and determine, by using a prediction result of an object, update parameters associated with the object feature data.

The update parameters are used to update model parameters, and include a plurality of sub-parameters for the plurality of computational layers.

In step S420, the plurality of member devices separately divide the plurality of computational layers into first-type computational layers and second-type computational layers by using the plurality of sub-parameters. Sub-parameter values of the first-type computational layers fall within a specified range, and sub-parameter values of the second-type computational layers fall outside the specified range.

In step S430, the plurality of member devices separately perform privacy processing on the sub-parameters of the first-type computational layers to obtain processed sub-parameters, and separately send the processed sub-parameters to the server.

In step S440, the server separately performs aggregation for the computational layers based on processed sub-parameters sent by at least two member devices, to obtain aggregated sub-parameters corresponding respectively to the first-type computational layers, and sends the aggregated sub-parameters to a corresponding member device.

In step S450, the plurality of member devices separately receive the aggregated sub-parameters sent by the server, update the model parameters by using the aggregated sub-parameters and sub-parameters of the second-type computational layers, so that the updated model parameters are associated with the object feature data of the plurality of member devices.

The above-mentioned embodiment in FIG. 4 is an embodiment obtained based on the embodiment in FIG. 2. An implementation and descriptions of the embodiment in FIG. 4 are the same as an implementation and descriptions of the embodiment in FIG. 2. For details, references can be made to descriptions in FIG. 2.

The above-mentioned descriptions are descriptions of the embodiments of this application by using the client-server architecture as an example. The following briefly describes another embodiment of this application by using the peer-to-peer network architecture as an example. In the following descriptions, a difference between this embodiment and the above-mentioned embodiment shown in FIG. 2 is mainly described.

In this embodiment, step S210, step S220, and step S250 remain unchanged, and are the same as those in the embodiment shown in FIG. 2. In step S230, a process of performing privacy processing on the sub-parameters of the first computational layer by the member device to obtain processed sub-parameters is also the same as descriptions in the embodiment shown in FIG. 2.

After obtaining the processed sub-parameters, the member device does not send the processed sub-parameters to the server, but can send the processed sub-parameters to another member device, for example, can send the processed sub-parameters to all other member devices, or transmit the processed sub-parameters in an iterative transmission method in a chain formed by the plurality of member devices, or send the processed sub-parameters to another member device in a random transmission method. As such, any member device can obtain aggregated sub-parameters of the first-type computational layers. The aggregated sub-parameters are obtained through aggregation based on processed sub-parameters of at least two member devices, and are associated with object feature data of the at least two member device. Specifically, any member device can directly obtain aggregated sub-parameters determined by another member device, or can aggregate a plurality of processed sub-parameters obtained by the member device, to obtain aggregated sub-parameters.

In addition, the aggregated sub-parameters can be obtained through aggregation based on the processed sub-parameters of all the member devices, or can be obtained through aggregation based on the processed sub-parameters of some member devices in all the member devices. All the member devices are all member devices in the peer-to-peer network architecture.

In this embodiment, the sub-parameters that undergo privacy processing do not leak privacy data. The member device aggregates the sub-parameters that undergo privacy processing, so that the member device can be prevented from inferring a data feature based on sub-parameters of another member device. Therefore, data privacy can be preserved in an aggregation training process.

In this specification, “first” in the first-type computational layers and “second” in the text are used only for ease of distinction and description, and do not have any limited meaning.

Some specific embodiments of this specification are described in the above-mentioned content, and some other embodiments fall within the scope of the appended claims. In some cases, actions or steps described in the claims can be performed in a sequence different from that in the some embodiments and desired results can still be achieved. In addition, processes described in the accompanying drawings do not necessarily need a specific order or a sequential order shown to achieve the desired results. In some implementations, multitasking and parallel processing are also possible or may be advantageous.

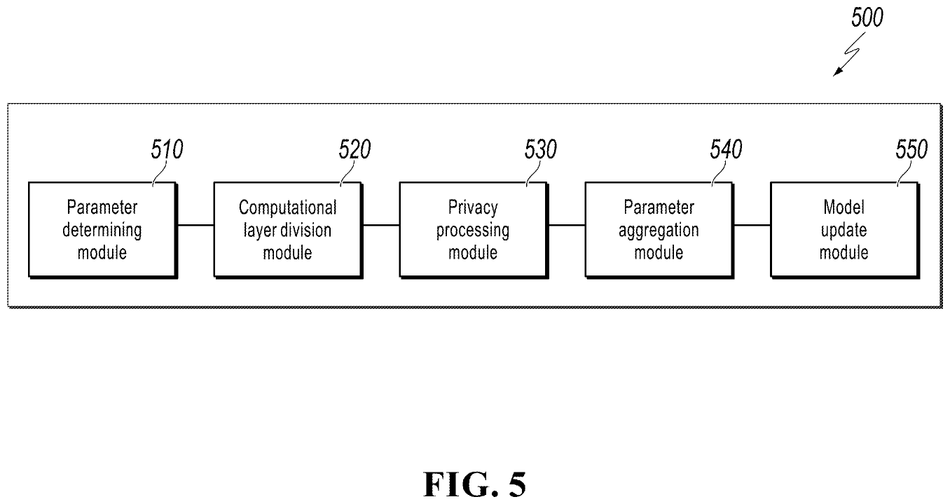

FIG. 5 is a schematic block diagram illustrating an apparatus for data privacy-preserving training of a service prediction model, according to an embodiment. According to the apparatus, a plurality of member devices perform joint training, and the service prediction model includes a plurality of computational layers. The apparatus embodiment corresponds to the method embodiment shown in FIG. 2. The apparatus is deployed in any member device, and includes: a parameter determining module 510, configured to perform prediction by using the service prediction model and object feature data that are of a plurality of objects and that are held by the member device, and determine, by using a prediction result of an object, update parameters associated with the object feature data, where the update parameters are used to update model parameters, and include a plurality of sub-parameters for the plurality of computational layers; a computational layer division module 520, configured to divide the plurality of computational layers into first-type computational layers and second-type computational layers by using the plurality of sub-parameters, where sub-parameter values of the first-type computational layers fall within a specified range, and sub-parameter values of the second-type computational layers fall outside the specified range; a privacy processing module 530, configured to perform privacy processing on the sub-parameters of the first-type computational layers, and output processed sub-parameters; a parameter aggregation module 540, configured to obtain aggregated sub-parameters of the first-type computational layers, where the aggregated sub-parameters are obtained through aggregation based on processed sub-parameters of at least two member devices, and are associated with object feature data of the at least two member devices; and a model update module 550, configured to update the model parameters by using the aggregated sub-parameters and sub-parameters of the second-type computational layers.

In implementations, the update parameters are implemented based on a model parameter gradient or a model parameter difference, and the model parameter gradient is determined based on a prediction loss obtained in current training; and the apparatus 500 further includes a difference determining module (not shown in the figure), configured to determine the model parameter difference according to the following method: obtaining initial model parameters in current training and a model parameter gradient obtained in current training; updating the initial model parameters by using the model parameter gradient, to obtain simulated update parameters; and determining the model parameter difference based on a difference between the initial model parameters and the simulated update parameters.

In implementations, the parameter determining module 510 is specifically configured to input the object feature data of the object into the service prediction model, and process the object feature data by using the plurality of computational layers that include the model parameters in the service prediction model, to obtain the prediction result of the object; determine a prediction loss based on a difference between the prediction result of the object and label information of the object; and determine, based on the prediction loss, the update parameters associated with the object feature data.

In implementations, the computational layer division module 520 is specifically configured to determine a plurality of sub-parameter representation values corresponding respectively to the plurality of sub-parameters by using vector elements included in the sub-parameters, where a sub-parameter representation value is used to represent a value of a corresponding sub-parameter; and divide the plurality of computational layers into the first-type computational layers and the second-type computational layers by using the plurality of sub-parameter representation values.

In implementations, the sub-parameter representation value is implemented by using one of the following values: a norm value, a mean value, a variance value, a standard deviation value, a maximum value, a minimum value, or a difference between a maximum value and a minimum value.

In implementations, the sub-parameter representation values of the first-type computational layers are greater than the sub-parameter representation values of the second-type computational layers.

In implementations, the specified range includes that orders of magnitude of the plurality of sub-parameter values fall within a predetermined order of magnitude range.

In implementations, the privacy processing module 530 is specifically configured to determine noise data for the sub-parameters of the first-type computational layers based on an (ϵ, δ)-differential privacy algorithm; and separately combining the noise data with corresponding sub-parameters of the first-type computational layers to obtain corresponding processed sub-parameters.

In implementations, that the privacy processing module 530 determines noise data for the sub-parameters of the first-type computational layers includes: calculating a noise variance value of Gaussian noise by using differential privacy parameters ϵ and δ; and generating, based on the noise variance value, corresponding noise data for vector elements included in the sub-parameters of the first-type computational layers.

In implementations, before the separately combining the noise data with corresponding sub-parameters of the first-type computational layers, the privacy processing module 530 further includes: determining, by using several sub-parameters corresponding to the first-type computational layers, an overall representation value used to identify the sub-parameters of the first-type computational layers; and performing numerical clipping on the sub-parameters of the first-type computational layers by using the overall representation value and a predetermined clipping parameter, to obtain corresponding clipped sub-parameters.

That the privacy processing module 530 separately combines the noise data with corresponding sub-parameters of the first-type computational layers includes: separately combining the noise data with the corresponding clipped sub-parameters of the first-type computational layers.

In implementations, the model update module 550 is specifically configured to perform numerical clipping on the sub-parameters of the second-type computational layers by using the overall representation value and the predetermined clipping parameter, to obtain corresponding clipped sub-parameters; and update the model parameters by using the aggregated sub-parameters and the clipped sub-parameters of the second-type computational layers.

In implementations, the apparatus 500 further includes a model prediction module (not shown in the figure), configured to obtain object feature data of an object to be predicted after the service prediction model is trained; and determine a prediction result of an object to be predicted by using the object feature data of the object to be predicted and the trained service prediction model.

In implementations, the plurality of computational layers trained in the member device are all or some computational layers of the service prediction model.

In implementations, the object includes one of a user, a product, a transaction, and an event; the object feature data includes at least one of the following feature groups: basic attribute features of the object, historical behavior features of the object, association relationship features of the object, interaction features of the object, and physical indicators of the object.

In implementations, the service prediction model is implemented by using a DNN, a CNN, an RNN, or a GNN.

The above-mentioned apparatus embodiments correspond to the method embodiments. For detailed descriptions, references can be made to descriptions of the method embodiments, and details are omitted here for simplicity. The apparatus embodiments are obtained based on the corresponding method embodiments, and have the same technical effects as the corresponding method embodiments. For detailed descriptions, references can be made to the corresponding method embodiments.

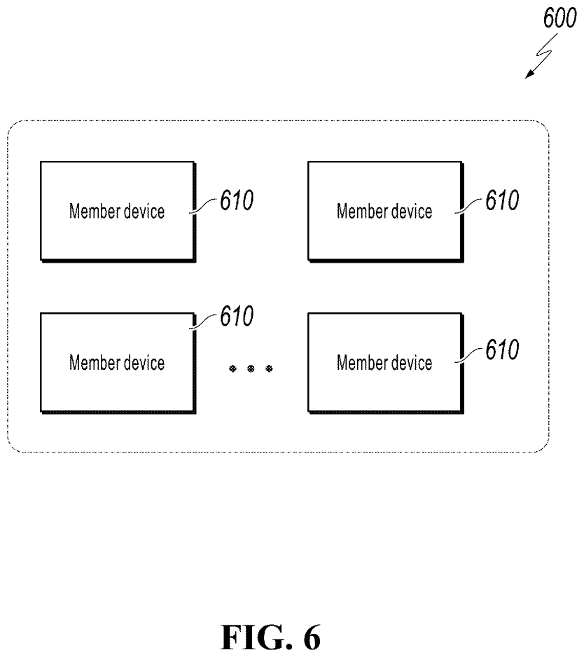

FIG. 6 is a schematic block diagram illustrating a system for data privacy-preserving training of a service prediction model, according to an embodiment. The system 600 includes a plurality of member device 610, where the service prediction model includes a plurality of computational layers, where the plurality of member devices 610 are configured to separately perform prediction by using the service prediction model and object feature data that are of a plurality of objects and that are respectively held by the plurality of member devices, and determine, by using a prediction result of an object, update parameters associated with the object feature data, where the update parameters are used to update model parameters, and includes a plurality of sub-parameters for the plurality of computational layers; separately divide the plurality of computational layers into first-type computational layers and second-type computational layers by using the plurality of sub-parameters, where sub-parameter values of the first-type computational layers fall within a specified range, and sub-parameter values of the second-type computational layers fall outside the specified range; separately perform privacy processing on the sub-parameters of the first-type computational layer, and output processed sub-parameters; and separately obtain aggregated sub-parameters of the first-type computational layers, and update the model parameters by using the aggregated sub-parameters and sub-parameters of the second-type computational layers, where the aggregated sub-parameters are obtained through aggregation based on processed sub-parameters of at least two member devices, and are associated with object feature data of the at least two member devices.

In implementations, when outputting the processed sub-parameters, the member device 610 can send the processed sub-parameters to another member device. The member device 610 obtains aggregated sub-parameters from another member device. Alternatively, the member device 610 obtains the processed sub-parameters from another member device, and aggregates processed sub-parameters of at least two member devices to obtain aggregated sub-parameters.

In implementations, the system 600 can further include a server (not shown in the figure). The member device 610 can send the processed sub-parameters to the server, and receive aggregated sub-parameters sent by the server. The server separately performs aggregation for the computational layers based on processed sub-parameters sent by at least two member devices, to obtain aggregated sub-parameters corresponding respectively to the first-type computational layers, and sends the aggregated sub-parameters to a corresponding member device.

An embodiment of this specification further provides a computer-readable storage medium. The computer-readable storage medium stores a computer program. When the computer program is executed in a computer, the computer is enabled to perform the method in any of FIG. 1A and FIG. 1B to FIG. 4.

An embodiment of this specification further provides a computing device, including a memory and processor. The memory stores executable code, and when executing the executable code, the processor implements the method in any of FIG. 1A and FIG. 1B to FIG. 4.

The embodiments in this specification are described in a progressive way. For same or similar parts of the embodiments, references can be made to the embodiments mutually. Each embodiment focuses on a difference from other embodiments. Particularly, storage medium embodiments and computing device embodiments are basically similar to the method embodiments, and therefore are described briefly. For a related part, references can be made to the descriptions in the method embodiments.

A person skilled in the art should be aware that in the above-mentioned one or more examples, functions described in embodiments of this application can be implemented by hardware, software, firmware, or any combination thereof. When implemented by using software, these functions can be stored in a computer-readable medium or transmitted as one or more instructions or code on a computer-readable medium.

The objectives, technical solutions, and beneficial effects of embodiments of this application have been described in more detail with reference to the specific implementations. It should be understood that the above-mentioned descriptions are merely specific implementations of embodiments of this application and are not intended to limit the protection scope of this application. Any modification, equivalent replacement, or improvement made based on the technical solutions of this application shall fall within the protection scope of this application.

What is claimed is:

1. A method for data privacy-preserving training of a service prediction model, wherein a plurality of member devices perform joint training, the service prediction model comprises a plurality of computational layers, and the method is performed by a member device and comprises:
performing prediction by using the service prediction model and object feature data that are of a plurality of objects and that are held by the member device;
determining, by using a prediction result of an object, update parameters associated with the object feature data, wherein the update parameters are used to update model parameters and comprise a plurality of sub-parameters for the plurality of computational layers;
dividing the plurality of computational layers into first-type computational layers and second-type computational layers by using the plurality of sub-parameters, wherein sub-parameter values of the first-type computational layers fall within a specified range, and sub-parameter values of the second-type computational layers fall outside the specified range;
performing privacy processing on the sub-parameters of the first-type computational layers;
outputting processed sub-parameters of the first-type computational layers;
obtaining aggregated sub-parameters of the first-type computational layers, wherein the aggregated sub-parameters are obtained through aggregation based on processed sub-parameters of at least two member devices and are associated with object feature data of the at least two member devices; and
updating the model parameters by using the aggregated sub-parameters of the first-type computational layers and sub-parameters of the second-type computational layers.

2. The method according to claim 1, wherein the update parameters are implemented based on a model parameter gradient or a model parameter difference, and the model parameter gradient is determined based on a prediction loss obtained in current training; and
the model parameter difference is determined according to the following method:
obtaining initial model parameters in current training and a model parameter gradient obtained in current training;
updating the initial model parameters by using the model parameter gradient to obtain simulated update parameters; and
determining the model parameter difference based on a difference between the initial model parameters and the simulated update parameters.

3. The method according to claim 1, wherein the dividing the plurality of computational layers into first-type computational layers and second-type computational layers comprises:
determining a plurality of sub-parameter representation values corresponding respectively to the plurality of sub-parameters by using vector elements comprised in the sub-parameters, wherein a sub-parameter representation value is used to represent a value of a corresponding sub-parameter; and
dividing the plurality of computational layers into the first-type computational layers and the second-type computational layers by using the plurality of sub-parameter representation values.

4. The method according to claim 3, wherein the sub-parameter representation value is implemented by using one of a norm value, a mean value, a variance value, a standard deviation value, a maximum value, a minimum value, or a difference between a maximum value and a minimum value.

5. The method according to claim 3, wherein the sub-parameter representation values of the first-type computational layers are greater than the sub-parameter representation values of the second-type computational layers.

6. The method according to claim 1, wherein the sub-parameter values of the first-type computational layers fall within a specified range comprises that orders of magnitude of the plurality of sub-parameter values fall within a predetermined magnitude range.

7. The method according to claim 1, wherein the performing privacy processing on sub-parameters of the first-type computational layers comprises:
determining noise data for the sub-parameters of the first-type computational layers based on an (ϵ, δ)-differential privacy algorithm; and
separately combining the noise data with corresponding sub-parameters of the first-type computational layers to obtain corresponding processed sub-parameters.

8. The method according to claim 7, wherein the determining noise data for the sub-parameters of the first-type computational layers comprises:
calculating a noise variance value of Gaussian noise by using differential privacy parameters ϵ and δ; and
generating, based on the noise variance value, corresponding noise data for vector elements comprised in the sub-parameters of the first-type computational layers.

9. The method according to claim 7, before the separately combining the noise data with corresponding sub-parameters of the first-type computational layers, further comprising:
determining, by using several sub-parameters corresponding to the first-type computational layers, an overall representation value used to identify the sub-parameters of the first-type computational layers; and
performing numerical clipping on the sub-parameters of the first-type computational layers by using the overall representation value and a predetermined clipping parameter to obtain corresponding clipped sub-parameters of the first-type computational layers; and
wherein the separately combining the noise data with corresponding sub-parameters of the first-type computational layers comprises:
separately combining the noise data with the corresponding clipped sub-parameters of the first-type computational layers.

10. The method according to claim 9, wherein the updating the model parameters comprises:
performing numerical clipping on the sub-parameters of the second-type computational layers by using the overall representation value and the predetermined clipping parameter to obtain corresponding clipped sub-parameters of the second-type computational layers; and
updating the model parameters by using the aggregated sub-parameters and the corresponding clipped sub-parameters of the second-type computational layers.

11. A method for data privacy-preserving training of a service prediction model, wherein a server and a plurality of member devices perform joint training, the service prediction model comprises a plurality of computational layers, and the method comprises:
separately performing, by the plurality of member devices, prediction by using the service prediction model and object feature data that are of a plurality of objects and that are respectively held by the plurality of member devices;
determining, by the plurality of member devices using a prediction result of the object, update parameters associated with the object feature data, wherein the update parameters are used to update model parameters and comprise a plurality of sub-parameters for the plurality of computational layers;
separately dividing, by the plurality of member devices, the plurality of computational layers into first-type computational layers and second-type computational layers by using the plurality of sub-parameters, wherein sub-parameter values of the first-type computational layers fall within a specified range, and sub-parameter values of the second-type computational layers fall outside the specified range;
separately performing, by the plurality of member devices, privacy processing on the sub-parameters of the first-type computational layers;
separately sending, by the plurality of member devices, obtained processed sub-parameters to the server;
performing, by the server, aggregation for the computational layers based on processed sub-parameters sent by at least two member devices to obtain aggregated sub-parameters corresponding respectively to the first-type computational layers; and
sending the aggregated sub-parameters to a corresponding member device; and
separately receiving, by the plurality of member devices, the aggregated sub-parameters sent by the server; and
updating, by the plurality of member devices, the model parameters by using the aggregated sub-parameters and sub-parameters of the second-type computational layers.

12. An apparatus for data privacy-preserving training of a service prediction model, wherein a plurality of member devices perform joint training, the service prediction model comprises a plurality of computational layers, and the apparatus comprises:
one or more computers; and
one or more computer memory devices interoperably coupled with the one or more computers and having tangible, non-transitory, machine-readable media storing one or more instructions that, when executed by the one or more computers, perform one or more operations comprising:
performing prediction by using the service prediction model and object feature data that are of a plurality of objects and that are held by the member device;
determining, by using a prediction result of an object, update parameters associated with the object feature data, wherein the update parameters are used to update model parameters and comprise a plurality of sub-parameters for the plurality of computational layers;
dividing the plurality of computational layers into first-type computational layers and second-type computational layers by using the plurality of sub-parameters, wherein sub-parameter values of the first-type computational layers fall within a specified range, and sub-parameter values of the second-type computational layers fall outside the specified range;
performing privacy processing on the sub-parameters of the first-type computational layers;
outputting processed sub-parameters of the first-type computational layers;
obtaining aggregated sub-parameters of the first-type computational layers, wherein the aggregated sub-parameters are obtained through aggregation based on processed sub-parameters of at least two member devices and are associated with object feature data of the at least two member devices; and
updating the model parameters by using the aggregated sub-parameters of the first-type computational layers and sub-parameters of the second-type computational layers.

13. The apparatus according to claim 12, wherein the update parameters are implemented based on a model parameter gradient or a model parameter difference, and the model parameter gradient is determined based on a prediction loss obtained in current training; and
the model parameter difference is determined according to the following method:
obtaining initial model parameters in current training and a model parameter gradient obtained in current training;
updating the initial model parameters by using the model parameter gradient to obtain simulated update parameters; and
determining the model parameter difference based on a difference between the initial model parameters and the simulated update parameters.

14. The apparatus according to claim 12, wherein the dividing the plurality of computational layers into first-type computational layers and second-type computational layers comprises:
determining a plurality of sub-parameter representation values corresponding respectively to the plurality of sub-parameters by using vector elements comprised in the sub-parameters, wherein a sub-parameter representation value is used to represent a value of a corresponding sub-parameter; and
dividing the plurality of computational layers into the first-type computational layers and the second-type computational layers by using the plurality of sub-parameter representation values.

15. The apparatus according to claim 14, wherein the sub-parameter representation value is implemented by using one of a norm value, a mean value, a variance value, a standard deviation value, a maximum value, a minimum value, or a difference between a maximum value and a minimum value.

16. The apparatus according to claim 14, wherein the sub-parameter representation values of the first-type computational layers are greater than the sub-parameter representation values of the second-type computational layers.

17. The apparatus according to claim 12, wherein the sub-parameter values of the first-type computational layers fall within a specified range comprises that orders of magnitude of the plurality of sub-parameter values fall within a predetermined magnitude range.

18. The apparatus according to claim 12, wherein the performing privacy processing on sub-parameters of the first-type computational layers comprises:
determining noise data for the sub-parameters of the first-type computational layers based on an (ϵ, δ)-differential privacy algorithm; and
separately combining the noise data with corresponding sub-parameters of the first-type computational layers to obtain corresponding processed sub-parameters.

19. The apparatus according to claim 18, wherein the determining noise data for the sub-parameters of the first-type computational layers comprises:
calculating a noise variance value of Gaussian noise by using differential privacy parameters ϵ and δ; and
generating, based on the noise variance value, corresponding noise data for vector elements comprised in the sub-parameters of the first-type computational layers.

20. The apparatus according to claim 18, wherein, before the separately combining the noise data with corresponding sub-parameters of the first-type computational layers, the one or more operations further comprise:
determining, by using several sub-parameters corresponding to the first-type computational layers, an overall representation value used to identify the sub-parameters of the first-type computational layers; and
performing numerical clipping on the sub-parameters of the first-type computational layers by using the overall representation value and a predetermined clipping parameter to obtain corresponding clipped sub-parameters of the first-type computational layers; and
wherein the separately combining the noise data with corresponding sub-parameters of the first-type computational layers comprises:
separately combining the noise data with the corresponding clipped sub-parameters of the first-type computational layers.
